(19) United States
(12) Patent Application Publication
(10) Pub. No.: US 2026/0275461 A1
(43) Pub. Date: Sep. 17, 2026

(54) SUSPENSION ARM AND MANUFACTURING METHOD THEREFOR

(71) Applicant: Resonac Corporation, Tokyo (JP)

(72) Inventors: Hiroshi SHIMIZU, Tokyo (JP); Hiroaki MURAKAMI, Tokyo (JP); Yoshifumi KIMURA, Tokyo (JP); Takuya ARAYAMA, Tokyo (JP)

(73) Assignee: Resonac Corporation, Tokyo (JP)

(21) Appl. No.: 19/473,520

(22) PCT Filed: Aug. 22, 2024
(86) PCT No.: PCT/JP2024/029837

§ 371 Date: Oct. 8, 2025

(30) Foreign Application Priority Data
Sep. 12, 2023 (JP) 2023-147762

(51) Int. Cl. C22C 21/08; B60G 7/00; C22F 1/047

(52) U.S. Cl. CPC C22C 21/08; B60G 7/001; C22F 1/047; B60G 2206/124; B60G 2206/7102; B60G 2206/8101; B60G 2206/81022; B60G 2206/81062

(57) ABSTRACT

A suspension arm of an aluminum alloy containing 0.25 mass % or more and 0.37 mass % or less of Cu, 0.95 mass % or more and 1.25 mass % or less of Mg, 0.6 mass % or more and 0.75 mass % or less of Si, 0.05 mass % or more and 0.12 mass % or less of Mn, 0.15 mass % or more and 0.35 mass % or less of Fe, 0.25 mass % or less of Zn, 0.050 mass % or more and 0.26 mass % or less of Cr, 0.01 mass % or more and 0.1 mass % or less of Ti, 0.001 mass % or more and 0.03 mass % or less of B, and 0.0010 mass % or more and 0.050 mass % or less of Zr, and the remainder being Al and unavoidable impurities, the suspension arm having a tensile strength ratio of a part with the minimum equivalent strain to a part with the maximum equivalent strain is 0.84 to 1.

### TECHNICAL FIELD

The present invention relates to a suspension arm and a manufacturing method therefor.

Priority is claimed on Japanese Patent Application No. 2023-147762, filed Sep. 12, 2023, the content of which is incorporated herein by reference.

### BACKGROUND ART

In recent years, aluminum alloys have been increasingly used for structural members for various products due to their light weight. For example, high-tensile steel has been used until now for automobile suspensions and bumper parts. On the other hand, high-strength aluminum alloy materials have come into use recently.

In addition, iron-based materials have been exclusively used for automobile parts, particularly, for example, suspension parts. On the other hand, in recent years, they have been increasingly replaced with aluminum materials or aluminum alloy materials mainly in order to reduce the weight.

Since excellent corrosion resistance, high-strength and excellent processability are required for these automobile parts, Al—Mg—Si-based alloys particularly, A6061, are often used as aluminum alloy materials. Thus, in order to improve the strength, such automobile parts are manufactured by performing forging processing, which is one type of plastic processing, using an aluminum alloy material as a processing material.

In addition, recently, since it is necessary to reduce costs, suspension parts obtained by directly forging cast members as materials without extrusion and then subjecting them to a treatment (T6 treatment) of performing a solution treatment and an artificial aging treatment have begun to be put into practical use, and in order to further reduce the weight, the development of high-strength alloys to replace conventional A6061 has progressed (for example, refer to Patent Documents 1 to 3).

### CITATION LIST

### Patent Document

### Patent Document 1

Japanese Unexamined Patent Application, First Publication No. H5-59477

### Patent Document 2

Japanese Unexamined Patent Application, First Publication No. H5-247574

### Patent Document 3

Japanese Unexamined Patent Application, First Publication No. H6-256880

### SUMMARY OF INVENTION

### Technical Problem

However, the above Al—Mg—Si-based high-strength alloys have problems that a processed structure recrystallizes in the forging and heat treatment process, coarse crystal grains are formed, and thus it is not possible to obtain sufficient high-strength. Therefore, in order to prevent formation of coarse recrystallized grains, recrystallization is sometimes prevented by adding Zr (zirconium) (for example, refer to Patent Documents 1 and 2).

However, addition of Zr is effective in preventing recrystallization, but it has the following problems.
(1) When Zr is added, the crystal grain refinement effect of Al—Ti—B-based alloys is weakened, crystal grains of the ingot itself coarsen, and a decrease in the strength of the processed product (forged product) after plastic processing is caused.
(2) Since the crystal grain refinement effect of the ingot itself is weakened, ingot cracks are more likely to occur, the number of internal defects increases, and the yield deteriorates.
(3) Zr forms compounds with Al—Ti—B-based alloys, the compounds are deposited on the bottom of the furnace in which the molten alloy is stored and contaminate the furnace, and in the manufactured ingot, these compounds crystallize coarsely in the ingot and reduce the strength.

In this manner, addition of Zr is effective in preventing recrystallization, but it is difficult to maintain the stability of strength.

In addition, during the forging procedure, hot plastic processing can cause changes in the structural state such as the occurrence of recrystallization, and variation in tensile strength may occur across parts within the same forged product.

The present invention has been made in view of such technical backgrounds, and an object of the present invention is to provide a suspension arm with reduced variation in tensile strength across parts and a method for manufacturing the same.

### Solution to Problem

In order to achieve the above objects, the present invention provides the following aspects.

Aspect 1 of the present invention is a suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, which is a forged product in which the ratio of the tensile strength of a part (T1) with the minimum equivalent strain to the tensile strength of a part (T4) with the maximum equivalent strain is 0.84 or more and 1 or less.

Aspect 2 of the present invention is the suspension arm according to Aspect 1, wherein the part with the minimum equivalent strain has a tensile strength of 350 MPa or more.

Aspect 3 of the present invention is a suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, composed of a pair of bifurcated arm parts, an arm connecting part disposed between the pair of arms, a wheel-side connecting part positioned at the starting point of bifurcations of the pair of arms, and vehicle body-side connecting parts provided at one end of each of the pair of arms, which is a forged product in which, in the pair of arms, the ratio of the tensile strength of the thinnest part to the tensile strength of the thickest part is 0.84 or more and 1 or less.

Aspect 4 of the present invention is the suspension arm according to Aspect 3, wherein the thickest part has a tensile strength of 350 MPa or more.

Aspect 5 of the present invention is a suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, which is a forged product in which the ratio of the tensile strength of a part with the largest proportion of large-angle grain boundaries with a crystal orientation difference of 15° or higher to the tensile strength of a part with the smallest proportion of large-angle grain boundaries with a crystal orientation difference of 15° or higher is 0.84 or more and 1 or less.

Aspect 6 of the present invention is the suspension arm according to Aspect 5, wherein the part with the smallest proportion of large-angle grain boundaries with a crystal orientation difference of 15° or higher has a tensile strength of 350 MPa or more. Aspect 7 of the present invention is the suspension arm according to any one of Aspect 1 to Aspect 6, wherein the equivalent strain due to forging processing is between 1.0 and 5.5.

Aspect 8 of the present invention is a method for manufacturing the suspension arm according to any one of Aspect 1 to Aspect 6, including a molten metal forming process in which a molten aluminum alloy is obtained, a casting process in which the obtained molten metal is cast to obtain a cast product, a forging process in which the cast product is subjected to plastic processing by performing material-heating at a temperature of 500° C. to a melting point without performing a homogenizing treatment process to obtain a forged product, a solution treatment process in which the obtained forged product is subjected to a solution treatment in which it is heated from 20° C. to 530° C. at a heating rate of 5.0° C./min or more and held at 530 to 560° C. for 0.3 to 3 hours, a quenching process in which, within 5 to 60 seconds after the solution treatment, the entire surface of the forged product is brought into contact with quenching water, and quenching is performed in a water tank for longer than 1 minute and 40 minutes or shorter, and an aging treatment process in which the forged product that has undergone the quenching treatment process is subjected to an aging treatment in which heating is performed at a temperature of 180° C. to 220° C. for 0.5 hours to 8 hours.

Aspect 9 of the present invention is the method for manufacturing a suspension arm according to Aspect 8, wherein the forging process is performed at a temperature of 500° C. or higher and 550° C. or lower, in the solution treatment process, a solution treatment in which holding is performed at 535° C. or higher and 555° C. or lower for 1 hour to 3 hours is performed, and in the aging treatment process, the forged product that has undergone the quenching treatment process is subjected to an aging treatment in which heating is performed at a temperature of 185° C. or higher and 205° C. or lower for 0.5 hours to 3 hours.

### Advantageous Effects of Invention

According to the present invention, it is possible to provide a suspension arm with reduced variation in tensile strength across parts.

### BRIEF DESCRIPTION OF DRAWINGS

FIG. 1 A schematic plan view showing an example of a suspension arm according to one embodiment of the present invention.

FIG. 2 An image of equivalent strain, determined by a computer simulation, including the entire first arm part.

FIG. 3 An image of equivalent strain, determined by a computer simulation, including the entire second arm part.

FIG. 4 A side cross-sectional view showing an example of a vertical continuous casting device that can manufacture a suspension arm according to one embodiment of the present invention.

FIG. 5 A bottom view illustrating a cooling method in the vertical continuous casting device shown in FIG. 4.

FIG. 6 A schematic perspective view illustrating a peeling process of an aluminum bar for enabling a suspension arm according to one embodiment of the present invention to be manufactured.

FIG. 7 A schematic side view illustrating the peeling process.

FIG. 8 A schematic cross-sectional view illustrating a surface profile of a peeled bar for forging.

FIG. 9 A partially enlarged schematic cross-sectional view of FIG. 8.

FIG. 10 A schematic plan view showing a T1 position and a T4 position in a suspension arm 100 shown in FIG. 1.

FIG. 11 A schematic plan view showing a mechanical property evaluation test piece produced in this example.

### DESCRIPTION OF EMBODIMENTS

Embodiments of the present invention will be described below in detail with reference to the drawings.

Here, in the drawings used in the following description, in order to facilitate understanding of features, featured parts are enlarged for convenience of illustration in some cases, and dimensional ratios of components are not necessarily the same as actual ones. In addition, materials, sizes and the like exemplified in the following description are only examples, and the present invention is not necessarily limited thereto and can be appropriately changed and implemented within a range not changing the effects.

### [Suspension Arm]

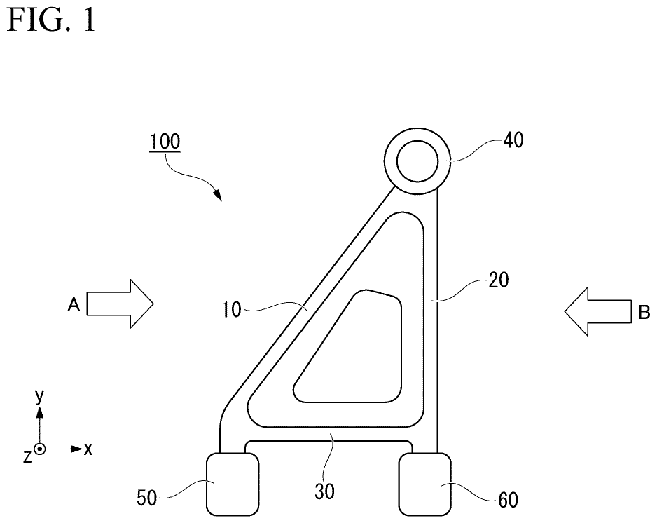

FIG. 1 is a schematic plan view of a suspension arm according to one embodiment of the present invention.

A suspension arm 100 shown in FIG. 1 includes a pair of bifurcated arm parts 10 and 20, an arm connecting part 30 disposed between the arm parts 10 and 20, a wheel-side connecting part 40 positioned at the starting point of bifurcations of the pair of arm parts 10 and 20, and vehicle body-side connecting parts 50 and 60 provided at one end of each of the pair of arm parts 10 and 20.

The wheel-side connecting part 40 and the vehicle body-side connecting parts 50 and 60 each have a hole part for connection to a wheel and a hole part for connection to a vehicle body.

The suspension arm 100 shown in FIG. 1 is a member known as an A-type arm or an A-arm.

In FIG. 1, the x-axis, the y-axis, and the z-axis are three orthogonal axes that constitute an orthogonal coordinate system. The plane of the paper is an xy plane, which is a plane passing through the wheel-side connecting part 40 and the vehicle body-side connecting parts 50 and 60.

In the suspension arm 100 shown in FIG. 1, between the pair of arm parts 10 and 20, the first arm part 10 is longer than the second arm part 20. The degree of difference in length between the pair of arm parts 10 and 20 is not particularly limited.

In addition, in the suspension arm 100 shown in FIG. 1, the arm connecting part 30 is disposed at a part of the arm parts 10 and 20 close to the vehicle body-side connecting parts 50 and 60, but the position is not particularly limited.

The suspension arm of the present invention is not particularly limited as long as it includes six components: a pair of bifurcated arm parts, an arm connecting part disposed between the pair of arm parts, one wheel-side connecting part positioned at the starting point of bifurcations of the pair of arm parts, and two vehicle body-side connecting parts provided at one end of each of the pair of arm parts. For example, the shapes and sizes of the arm part, the arm connecting part, the wheel-side connecting part and the vehicle body-side connecting part may be known.

The suspension arm of the present embodiment is a suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, which is a forged product in which the ratio of the tensile strength of a part with the maximum equivalent strain (mm/mm) to the tensile strength with a part with the minimum equivalent strain (mm/mm) is 0.84 or more and 1 or less.

The suspension arm of the present embodiment corresponds to a forged product of a 6000-series aluminum alloy in that it contains Mg and Si.

### (Cu: 0.25 Mass % or More and 0.37 Mass % or Less)

Cu has a function of finely dispersing a Mg—Si-based compound in the aluminum alloy and has a function of improving the tensile strength of the aluminum alloy by precipitating as an Al—Cu—Mg—Si-based compound including a Q phase. When the Cu content is within the above range, it is possible to improve the mechanical properties of the suspension arm 100 at room temperature.

### (Mg: 0.95 Mass % or More and 1.25 Mass % or Less)

Mg has a function of improving the tensile strength of the aluminum alloy. When Mg is solid-solutionized in an aluminum base phase or precipitates as Mg—Si-based compound (Mg₂Si) such as a β″ phase or an Al—Cu—Mg—Si-based compound (AlCuMgSi) including a Q phase, it contributes to strengthening of the aluminum alloy. In addition, Mg₂Si has a function of minimizing formation of a CuAl₂ phase in the aluminum alloy. When formation of a CuAl₂ phase is minimized, the corrosion resistance of the suspension arm 100 is improved. When the Mg content is within the above range, it is possible to improve the mechanical properties and corrosion resistance of the suspension arm 100 at room temperature.

### (Si: 0.6 Mass % or More and 0.75 Mass % or Less)

Like Mg, Si has a function of improving the mechanical properties and corrosion resistance of the suspension arm 100 at room temperature. However, when excessive Si is added to the aluminum alloy, there is a risk of coarse primary crystal Si grains crystallizing and the tensile strength of the aluminum alloy decreasing. When the Si content is within the above range, it is possible to improve the mechanical properties and corrosion resistance of the suspension arm 100 at room temperature while minimizing crystallization of primary crystal Si.

### (Mn: 0.05 Mass % or More and 0.12 Mass % or Less)

Mn has a function of improving the tensile strength of the aluminum alloy by forming fine granular crystals containing intermetallic compounds such as Al—Mn—Fe—Si and Al—Mn—Cr—Fe—Si in the aluminum alloy. When the Mn content is within the above range, it is possible to improve the mechanical properties of the suspension arm 100 at room temperature.

### (Fe: 0.15 Mass % or More and 0.35 Mass % or Less)

Fe has a function of improving the tensile strength of the aluminum alloy by forming crystals in the aluminum alloy as fine crystals containing intermetallic compounds such as Al—Mn—Fe—Si, Al—Mn—Cr—Fe—Si, Al—Fe—Si, Al—Cu—Fe, and Al—Mn—Fe. When the Fe content is within the above range, it is possible to improve the mechanical properties of the suspension arm 100 at room temperature.

### (Cr: 0.050 Mass % or More and 0.26 Mass % or Less)

Cr has a function of improving the tensile strength of the aluminum alloy by forming fine granular crystals containing intermetallic compounds such as Al—Mn—Cr—Fe—Si and Al—Fe—Cr in the aluminum alloy. When the Cr content is within the above range, it is possible to improve the mechanical properties of the suspension arm 100 at room temperature.

### (Ti: 0.01 Mass % or More and 0.1 Mass % or Less)

Ti has a function of refining aluminum alloy crystal grains and improving stretching processability. When the Ti content is less than 0.01 mass %, there is a risk of a sufficient crystal grain refinement effect not being obtained. On the other hand, when the Ti content is more than 0.1 mass %, there is a risk of coarse crystals being formed and stretching processability deteriorating. In addition, when a large amount of coarse crystals containing Ti are mixed into the suspension arm 100, the toughness may decrease. Therefore, the Ti content is 0.012 mass % or more and 0.035 mass % or less. The Ti content is preferably 0.015 mass % or more and 0.050 mass % or less.

### (B: 0.001 Mass % or More and 0.03 Mass % or Less)

B has a function of refining aluminum alloy crystal grains and improving stretching processability. When B is added to the aluminum alloy together with the above Ti, the crystal grain refinement effect is improved. When the B content is less than 0.0010 mass %, there is a risk of a sufficient crystal grain refinement effect not being obtained. On the other hand, when the B content is more than 0.030 mass %, there is a risk of coarse crystals being formed and mixed into the suspension arm 100 as inclusions. In addition, when a large amount of coarse crystals containing B are mixed into the final aluminum alloy product, the toughness may decrease. Therefore, the B content is 0.0010 mass % or more and 0.030 mass %. The B content is preferably 0.0050 mass % or more and 0.025 mass %.

### (Zr: 0.0010 Mass % or More and 0.05 Mass % or Less)

When the Zr content is 0.05 mass % or less, it precipitates in the forms of Al₃Zr and Al—(Ti, Zr), and thus contributes to improving the strength of the suspension arm 100 according to the recrystallization minimizing effect and precipitation strengthening. When the Zr content is more than 0.050 mass %, it crystallizes as a coarse Zr compound, and thus there is a risk of the corrosion resistance of the suspension arm 100 decreasing. Therefore, the Zr content is 0.050 mass % or less. In addition, in order to obtain the above recrystallization minimizing effect and the effect of improving the strength of the forged product according to precipitation strengthening, the Zr content is preferably 0.0010 mass % or more.

### (Zn: 0.250 Mass % or Less)

The Zn content may be 0.250 mass % or less. When the Zn content is more than 0.250 mass %, MgZn₂ is formed and precipitates from an Al base phase to the grain boundaries, causing intergranular corrosion, and leading to a decrease in the corrosion resistance of the suspension arm. Therefore, it is preferable that the Zn content be 0.250 mass % or less or that it not be included at all.

### (Unavoidable Impurities)

Unavoidable impurities are impurities that are unavoidably mixed into the aluminum alloy from raw materials or in the manufacturing process. Examples of unavoidable impurities include Ni, Sn, and Be. It is preferable that the content of these unavoidable impurities be not more than 0.1 mass %.

The suspension arm of the present embodiment is a forged product in which the ratio of the tensile strength of a part with the maximum equivalent strain to the tensile strength of a part with the minimum equivalent strain is 0.84 or more and 1 or less. Here, when the shapes of a forging material to be used and a forged product (forged member) to be manufactured are provided, the equivalent strain at each part can be determined by performing a computer simulation based on the finite element method according to the procedure of molding from the shape of the forging material to the shape of the forged product. Examples of software used in this simulation include forging analysis software “DEFORM.”

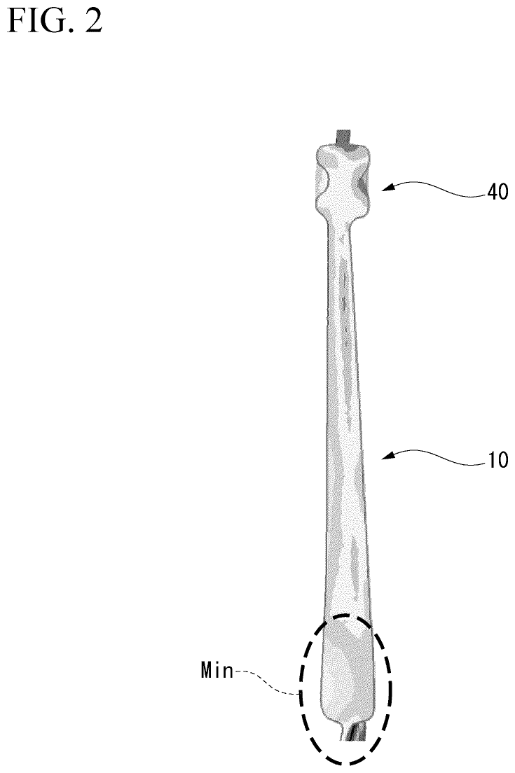

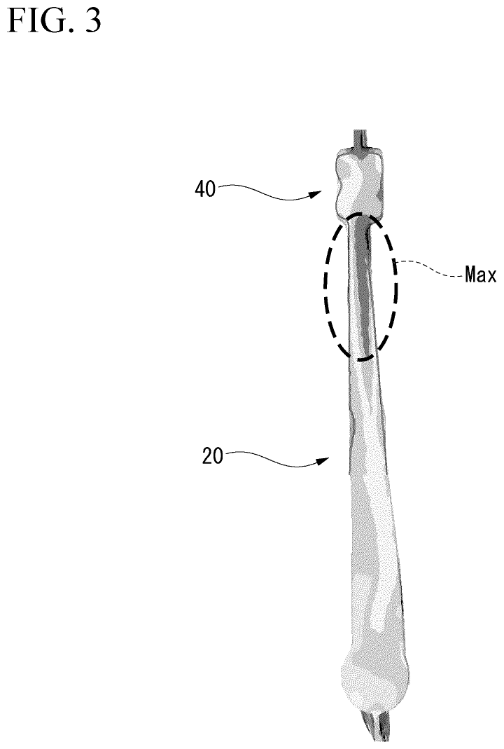

FIG. 2 and FIG. 3 are simulation images of equivalent strains obtained by performing a computer simulation on the suspension arm 100 shown in FIG. 1 using forging analysis software “DEFORM,” and are an equivalent strain image viewed in an A direction (positive direction on the x-axis) and an equivalent strain image viewed in a B direction (negative direction on the x-axis), respectively. That is, FIG. 2 is an equivalent strain image including the entire first arm part 10, and FIG. 3 is an equivalent strain image including the entire second arm part 20.

As a result of the simulation, it can be understood that, in the suspension arm 100 shown in FIG. 1, the part with the maximum equivalent strain is a part of the second arm part 20 close to the wheel-side connecting part 40, which is indicated by the symbol Max in FIG. 3, and the part with the minimum equivalent strain is a part of the first arm part 10 close to the vehicle body-side connecting part 50, which is indicated by the symbol Min in FIG. 2.

The suspension arm of the present invention is a “forged product in which the ratio of the tensile strength of the part with the maximum equivalent strain to the tensile strength of the part with the minimum equivalent strain is 0.84 or more and 1 or less.” Here, “part with the maximum equivalent strain” refers to a region with a length range of 25.4 mm where the equivalent strain determined by a simulation is the maximum, and “part with the minimum equivalent strain” refers to a region with a length range of 25.4 mm where the equivalent strain determined by a simulation is the minimum.

During the forging procedure, hot plastic processing can cause changes in the structural state such as the occurrence of recrystallization. This can lead to variation in strength across parts within the same forged product. The present invention has been completed by forging a material using a 6000-series aluminum alloy continuous casting bar without performing a homogenizing treatment and enabling the tensile strength ratio between a region with a high equivalent strain and a region with a low equivalent strain to be within a range of 0.84 or more and 1 or less.

It is thought that, when an aluminum alloy continuous casting bar having a 6000-series component composition is forged without performing a homogenizing treatment, the precipitate becomes finer than those that have undergone a homogenizing treatment. This makes the precipitation strengthening of the compound more effective, and the strength is less likely to decrease even in parts with high equivalent strain where recrystallization would occur. As a result, it is thought that, even for 6000-series aluminum alloy forged products with significant variation in equivalent strain across parts, products with relatively small variation in strength can be obtained.

In addition, based on the simulation results, it can be understood that, in both the first arm part and the second arm part, the “part with the maximum equivalent strain” and the “part with the minimum equivalent strain” are the thinnest part and the thickest part, respectively.

In addition, it can be understood that, comparing the “part with the maximum equivalent strain” and the “part with the minimum equivalent strain” between the longer first arm part and the shorter second arm part, the “part with the maximum equivalent strain” is larger in the shorter second arm part, and the “part with the minimum equivalent strain” is smaller in the longer first arm part.

In the suspension arm 100 shown in FIG. 1, both the first arm part 10 and the second arm part 20 have the thinnest part close to the wheel-side connecting part 40 and the thickest part close to the vehicle body-side connecting parts 50 and 60.

The suspension arm of the present embodiment is a forged product in which, in the first arm part and the second arm part, the ratio of the tensile strength of the thickest part to the tensile strength of the thinnest part is 0.84 or more and 1 or less.

Crystal grain boundaries (large-angle grain boundaries) with a crystal orientation difference of 15° or higher are indicators of the degree of progress of recrystallization in each part of the suspension arm 100. The proportion of large-angle grain boundaries can be obtained from an EBSD image.

The “part with the maximum equivalent strain” and the “part with the minimum equivalent strain” correspond to a part with the largest proportion of large-angle grain boundaries with a crystal orientation difference of 15° or higher and a part with the smallest proportion of large-angle grain boundaries with a crystal orientation difference of 15° or higher, respectively.

The suspension arm of the present embodiment is a forged product in which the ratio of the tensile strength of the part with the largest proportion of large-angle grain boundaries with a crystal orientation difference of 15° or higher to the tensile strength of the part with the smallest proportion of large-angle grain boundaries with a crystal orientation difference of 15° or higher is 0.84 or more and 1 or less.

Since the aluminum alloy from which the suspension arm 100 of the present embodiment configured as described above is made has the above alloy composition, recrystallization is unlikely to occur when a forged product is manufactured. Therefore, excessively coarse crystal grains are less likely to be formed.

Because the suspension arm 100 of the present embodiment exhibits low variation in strength, it is suitable as a suspension arm for vehicles such as automobiles.

### [Method for Manufacturing Suspension Arm]

Next, a method for manufacturing a suspension arm of the present embodiment will be described.

The method for manufacturing a suspension arm of the present embodiment includes, for example, a molten metal forming process, a casting process, a forging process, a solution treatment process, a quenching treatment process, and an aging treatment process.

### (Molten Metal Forming Process)

The molten metal forming process is a process in which raw materials are melted to obtain a molten aluminum alloy with an adjusted composition. The composition of the molten aluminum alloy is adjusted so that the alloy composition contains Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, and thereby a 6000-series molten aluminum alloy is obtained.

By using the molten aluminum alloy having the above composition in the subsequent processes, it is possible to obtain an Al—Mg—Si-based suspension arm that is resistant to recrystallization and exhibits excellent mechanical properties at room temperature. Here, a primary aluminum ingot is aluminum with a concentration of 99% or more obtained by subjecting alumina manufactured from minerals to electrolysis known as electrolytic refining.

The molten aluminum alloy can be obtained by heating and melting an aluminum alloy. In addition, it can be molded by melting a mixture containing a single element substance or a compound containing two or more elements as raw materials for the aluminum alloy in proportions suitable to form a desired aluminum alloy. For example, in order to control the crystal grain size of the aluminum alloy formed in the casting process, Ti and B may be mixed as crystal grain refining materials such as Al—Ti-B rods.

In addition, the molten aluminum alloy may be obtained by using 10% or more of scrap material from 1000-series, 2000-series, 3000-series, 4000-series, 5000-series, 6000-series, or 7000-series aluminum alloys as raw materials for the molten aluminum alloy, with the remainder being made up of a primary aluminum ingot and the above additive elements, and melting them to adjust the composition. In this case, it is possible to obtain an Al—Mg—Si-based suspension arm that is resistant to recrystallization and exhibits excellent mechanical properties at room temperature. Here, the primary aluminum ingot is, for example, aluminum with a purity of 99% or more obtained by subjecting alumina manufactured from minerals to electrolysis known as electrolytic refining.

### (Casting Process)

In the casting process, a molten aluminum alloy (liquid phase) is cooled and solidified into a solid (solid phase) to obtain an aluminum alloy cast product. In the casting process, for example, a vertical continuous casting method can be used.

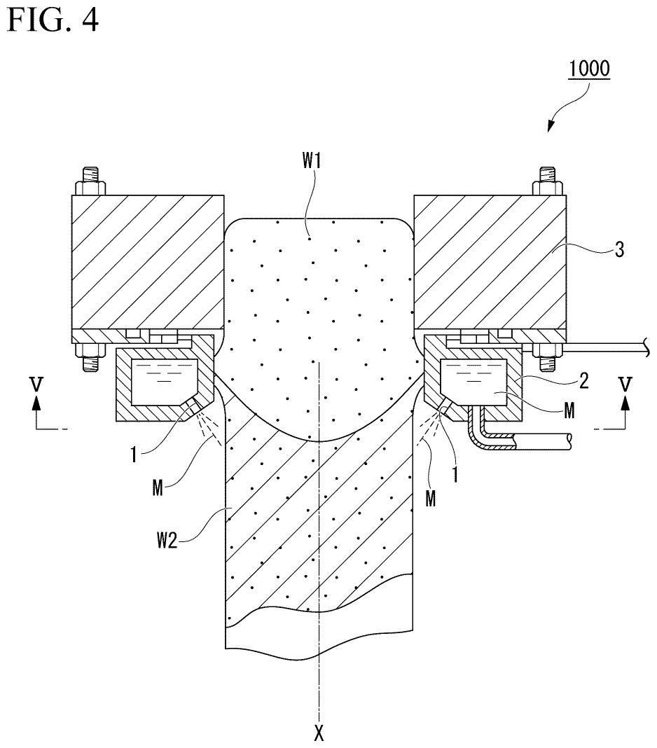

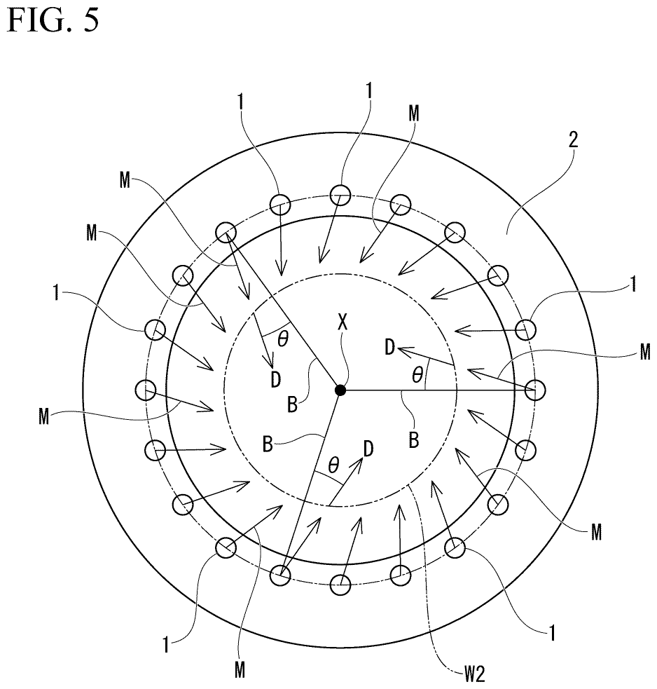

Here, FIG. 4 and FIG. 5 show a vertical continuous casting device that can be used to manufacture an aluminum alloy cast product.

FIG. 4 is a side cross-sectional view schematically showing a hot top casting device which is a vertical continuous casting device. The vertical continuous casting device has sufficient cooling performance and can manufacture a high-quality continuous casting material.

A vertical continuous casting device 1000 shown in FIG. 4 includes a mold 2 for solidifying molten aluminum W1 and casting an ingot W2 and a molten metal receiving tank 3 that is provided above the mold 2 and injects the molten metal W1 into the mold 2.

The mold 2 is cooled by cooling water M supplied thereinto as primary cooling water. In addition, at the lower end of the mold 2, as will be described below, a plurality of ejection ports 1 from which cooling water M in the mold 2 is ejected as secondary cooling water are provided at predetermined intervals in the circumferential direction.

In the casting device, the molten aluminum W1 as a metal supplied into the molten metal receiving tank 3 is injected into the cooled mold 2. The injected molten metal W1 is primarily cooled by contact with the mold 2 and a semi-solidified ingot W2 is formed. The semi-solidified ingot W2 has a solidified film formed on its outer periphery. Thus, the ingot W2 in this state passes continuously downward inside the mold 2, immediately after passing through the mold 2, cooling water M is ejected to the ingot W2 from the ejection port 1 of the mold 2, and the cooling water M comes into direct contact with the outer circumferential surface of the ingot W2 to cool the ingot W2. As the ingot W2 is pulled downward in this manner, it undergoes secondary cooling and most of it solidifies, and thereby a round bar-shaped continuous casting material (billet) is manufactured.

Next, a method for cooling the ingot W2 in the casting device will be described in detail. FIG. 5 is a schematic bottom view illustrating a cooling method in the casting device, and is a cross-sectional view corresponding to the V-V line cross section in FIG. 4. Here, FIG. 5 is a view of the casting device from below, along the axis of the ingot W2.

As shown in FIG. 4 and FIG. 5, a plurality of ejection ports 1 are provided on the lower inner circumferential surface of the mold 2 and formed at predetermined intervals in the circumferential direction. The ejection ports 1 are formed such that the ejection direction D of the cooling water M ejected therefrom is inclined in one direction with respect to the axis X so that it does not intersect the axis (central axis) X of the ingot W2. Specifically, as shown in FIG. 5, when the casting device is viewed from below along the axis X of the ingot W2 (the state in FIG. 5), if an imaginary axis line connecting the center of the ejection port 1 and the axis X of the ingot W2 is set as the projection reference axis B, the ejection direction D of the cooling water M ejected from each ejection port 1 is inclined in one direction with respect to the projection reference axis B.

In addition, in the casting device, when the angle at which the ejection direction D of the cooling water M is inclined with respect to the projection reference axis B is defined as an ejection angle θ, the ejection angles θ of the cooling water M ejected from the ejection ports 1 are all set to the same angle.

Here, in the casting device, on the plane of the paper of FIG. 5, each ejection direction D starts from the ejection port 1, and the tip side (ejection direction side) is inclined counterclockwise with respect to the projection reference axis B, and this counterclockwise direction is defined as one direction, but the present invention is not limited thereto, and in the present invention, the opposite direction (clockwise) may be defined as one direction. That is, on the plane of the paper of FIG. 5, each ejection direction D may start from the ejection port 1, and the tip side may be inclined clockwise with respect to the projection reference axis B.

As described above, in the casting device, when viewed from below, since the ejection direction D of the cooling water M ejected from the ejection port 1 of the mold 2 is inclined in one direction so that it does not intersect the axis X of the ingot W2 (the mold 2), the cooling water M is sprayed obliquely against the outer circumferential surface of the ingot W2 rather than perpendicularly to the outer circumferential surface of the ingot W2. Therefore, the cooling water M ejected from each ejection port 1 flows down in a spiral manner so that it wraps around the outer circumferential surface of the ingot W2. That is, when the cooling water M is obliquely projected to the outer circumferential surface of the ingot W2, the wettability (adhesion) between the cooling water M and the ingot W2 is improved, and at the same time, the surface tension and Coanda effect of the cooling water M with respect to the ingot W2 are improved, the cooling water M flows down in a spiral manner so that it wraps around the entire circumference of the ingot W2 without interruption, and the entire circumferential region of the ingot W2 is evenly cooled by the secondary cooling water M without any unevenness. Therefore, the ingot W2 is evenly cooled throughout the entire region, no partial insufficient cooling occurs, and sufficient cooling performance can be obtained. Furthermore, when the cooling water M flows down in a spiral manner along the outer circumferential surface of the ingot W2, the contact length (downflow path) of the cooling water M with respect to the ingot W2 becomes longer, the contact time between the cooling water M and the ingot W2 also becomes longer accordingly, and thereby the cooling performance can be further improved. As a result, it is possible to reliably prevent the occurrence of partial high temperature anomalies in the ingot W2, it is possible to remove partial high temperature anomalies that cause material segregation and stress concentration, it is possible to prevent defects such as ingot cracking, it is possible to significantly reduce the occurrence of poor quality, and it is possible to manufacture a continuous casting material as a high-quality ingot W2.

Here, in the casting device, some of the ejection ports 1 may be blocked for some reason, for example, deterioration of the mold or water supply pipe, but the entire circumferential region of the ingot W2 can be evenly cooled even in such a case. That is, since the cooling water M is obliquely projected to the outer circumferential surface of the ingot W2, compared to conventional projection of the cooling water M perpendicularly to the outer circumferential surface of the ingot W2, with respect to the outer circumferential surface of the ingot, the range of projection of the cooling water M ejected from each ejection port 1 to the ingot W2 is widened. Therefore, even if the cooling water M is not ejected from some of the ejection ports 1, the cooling water M2 can be projected to the entire circumference of the ingot W2 without interruption, and as described above, since the projected cooling water M flows down in a spiral manner so that it wraps around the outer circumferential surface of the ingot W2, the entire circumferential region of the ingot W2 can be evenly cooled. Even if some of the ejection ports 1 are blocked in this manner, the cooling water M is projected to compensate for the blocked portion, the entire circumferential region of the ingot W2 can be evenly cooled, sufficient cooling performance can be secured, the occurrence of poor quality can be reliably reduced, and a high-quality continuous casting material can be reliably manufactured.

As described above, according to the hot top casting device of the casting device, since ejection direction D of the cooling water M ejected from the ejection port 1 of the mold 2 is inclined, the entire circumferential region of the ingot W2 can be evenly cooled, sufficient cooling performance can be obtained, and a high-quality continuous casting material can be manufactured.

Here, in the casting device, as described above, in order to make the cooling water M flow down so that it wraps around the outer circumferential surface of the ingot W2 and evenly cool the entire circumference, the ejection angle θ of the cooling water M is preferably set to 3° to 45° and more preferably set to 5° to 20°.

As the forging material used in the next forging process, for example, a peeled bar obtained by cutting and removing the outer circumferential surface of a continuous casting bar obtained by casting according to peeling processing is used. Thus, a forging material formed from this peeled bar is subjected to forging processing by adhering a lubricant (lubricating oil) to its surface or adhering a lubricant to the inner circumferential surface of the mold of the forging device, and thereby forged products such as the above automobile parts are obtained. However, when the surface condition of the peeled bar used as the forging material is not stable, a uniform lubricating film is not formed over the entire region of the outer circumferential surface of the forging material as the peeled bar, the lubricating film is formed unevenly, and the effects of the lubricating film are not sufficiently obtained. Therefore, it is preferable to perform forging peeling which enables forged products with high dimensional accuracy to be obtained, and can improve the productivity and prolong the lifespan of the mold when forged products are manufactured.

As such forging peeling, the following methods can be used.

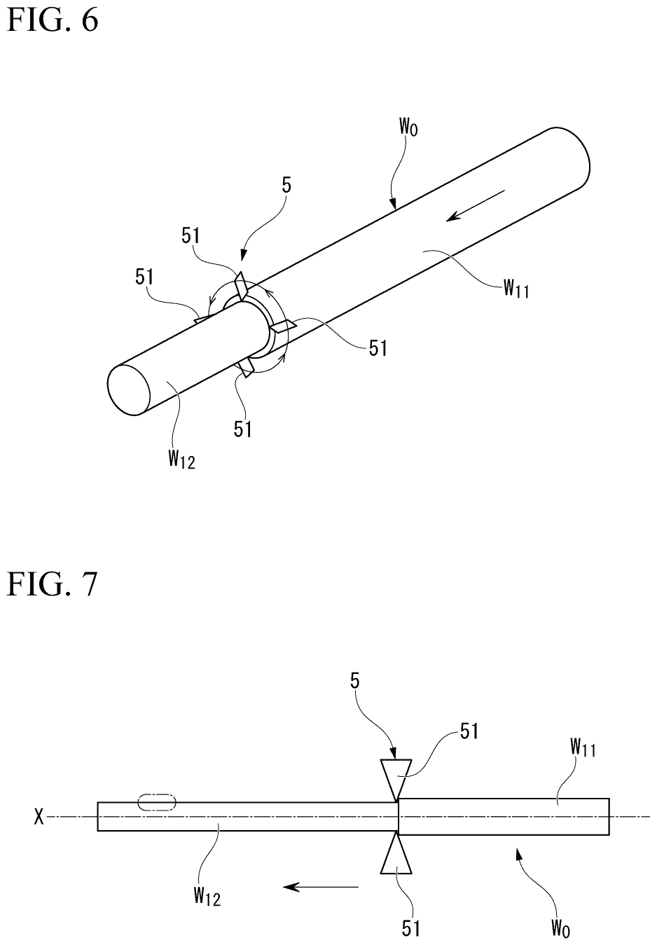

FIG. 6 and FIG. 7 are schematic views illustrating a peeling process. As shown in both figures, a cutting machine 5 is provided on the transfer line for the aluminum bar W₀. The cutting machine 5 has four cutting tools 51 spaced at equal intervals (at 90° intervals) in the circumferential direction along the outer circumferential surface of the aluminum bar W₀ transferred along the transfer line. In the present embodiment, in the cutting tool 51 in each region, a so-called combination bit having a pair of bit groups including four overlapping bits for rough processing and four overlapping bits for finishing processing is used.

In addition, although not shown, a workpiece transfer means such as a transfer roller, a support roller, and a carriage for transferring the aluminum bar W₀ along the transfer line is provided upstream and downstream from the transfer line of the cutting machine 5.

Here, the materials of cutting edges of the bits for rough processing and the bits for finishing processing constituting the combination bit are not particularly limited, and cemented carbide, diamond and the like can be preferably used, and among these, particularly, as the bits for finishing processing, diamond bits with a diamond cutting edge can be preferably used. In addition, in the present invention, the number of bits of the cutting tool 51 is not limited, and cutting tools other than combination bits may also be used.

In addition, in this method, when the aluminum bar W₀ is transferred along the transfer line while rotating the cutting tool 51 around the transfer line, the entire region of the outer circumferential surface of the aluminum bar W₀ is cut and removed by the cutting tool 51.

Here, the aluminum bar W₀ collectively refers to a continuous casting bar W₁₁ before peeling, a peeled bar (peeled bar for forging) W₁₂ after peeling, and a forging material obtained by cutting the peeled bar W₁₂.

In addition, during peeling processing, when cutting conditions such as the type of cutting bits, the shape of cutting edges of cutting bits, the rotation speed of cutting bits, and the feed rate of the aluminum bar W₀ are appropriately adjusted, a peeled bar W₁₂ having a surface profile with a unique configuration is obtained as described below.

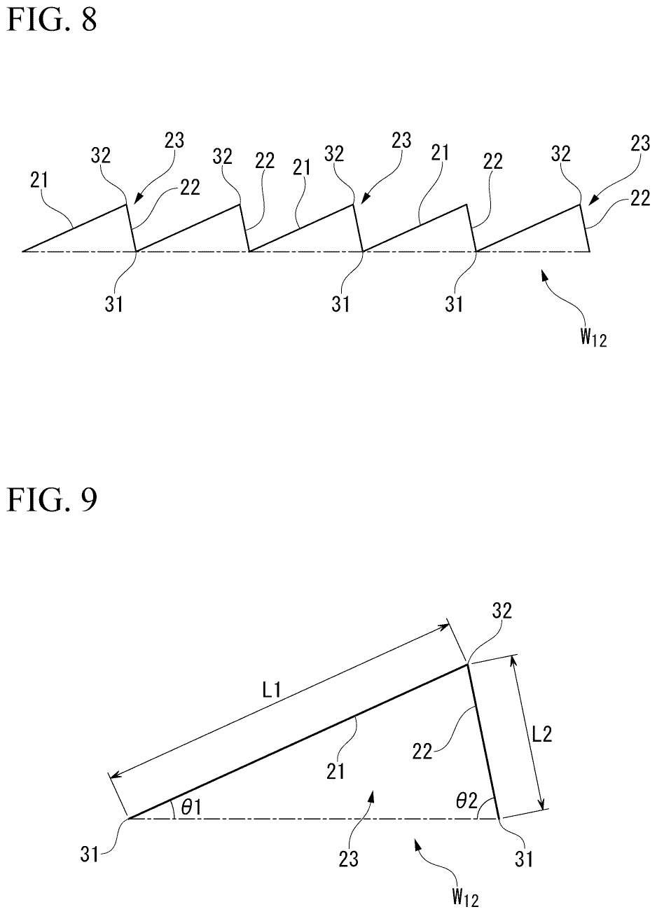

FIG. 8 is a schematic view showing the surface profile of the peeled bar W₁₂, and is a schematic view corresponding to an enlarged cross section of a part surrounded by the dashed line in FIG. 7. FIG. 9 is a further enlarged schematic view of the vicinity of the mountain-shaped part in FIG. 8. As shown in both figures, the outer circumferential surface of the peeled bar W₁₂ is formed in a substantially sawtooth-like shape or a substantially thunderbolt-like shape, with a large number of mountain-shaped parts 23 connected in the axis direction in the cross section. In addition, the lowest point between the adjacent mountain-shaped parts 23 is defined as a bottom 31, and the highest point of each mountain-shaped part 23 is defined as a peak 32.

Here, in this method, between two slopes (diagonal lines) forming the contour of each mountain-shaped part 23, the slope on one side in the axis direction, that is, the slope inclined upward from the left side to the right side in FIG. 8, is defined as a first slope 21, and the slope on the other side in the axis direction, that is, the slope inclined downward from the left side to the right side in FIG. 8, is defined as a second slope 22.

In addition, in this method, in the peeled bar W₁₂, the inclination angle (one base angle) θ1 of the first slope 21 relative to the axis X and the inclination angle (the other base angle) θ2 of the second slope 22 relative to the axis X are formed to have different sizes.

In this method, the inclination angle θ1 of the first slope 21 is preferably 1° to 30°, and the inclination angle θ2 of the second slope 22 is preferably 50° to 100°. That is, when the inclination angles θ1 and θ2 are within the above preferable range, it is possible to reliably obtain the effects of the lubricating film, which will be described below. On the other hand, when the inclination angles θ1 and θ2 are outside the above preferable range, there is a risk of the effects of the lubricating film not being sufficiently obtained.

In addition, in this method, in FIG. 9, a linear distance (length of the first slope 21) L1 from the bottom 31 to the peak 32 on the first slope 21 is preferably 1 mm to 20 mm, and a linear distance (length of the second slope 22) L2 from the peak 32 to the bottom 31 on the second slope 22 is preferably 0.1 μm to 50 μm. That is, when the slope lengths L1 and L2 are within the above preferable range, it is possible to reliably obtain the effects of the lubricating film, which will be described below. On the other hand, when the slope lengths L1 and L2 are outside the above preferable range, there is a risk of the effects of the lubricating film not being sufficiently obtained.

In this manner, the peeled bar W₁₂ having a unique surface profile is appropriately cut to form a forging material. Needless to say, this forging material also has the same surface profile as the peeled bar W₁₂.

### (Forging Process)

The forging process is a process in which the aluminum alloy cast product after casting is cut to a predetermined size, the forging material obtained by performing peeling by the above method is heated to a predetermined temperature, then pressurized with a press machine, and molded into a mold. In the present invention, forging processing is performed without a homogenizing treatment that has conventionally been performed after casting in order to remove segregation. Therefore, since it is necessary to perform the segregation removal that has been performed by the homogenizing treatment by material-heating during forging, material-heating should be performed at a temperature of 500° C. or higher and a melting point or lower. Then, forging processing is performed to obtain a forged product (for example, a suspension arm part for an automobile). When the material-heating temperature during forging is lower than 500° C., compounds such as AlFeSi— and Mg₂Si-based compounds in the alloy structure remain in a segregated state, the deformation resistance increases, sufficient processing is not possible, and cracks occur. In addition, if the melting point temperature is exceeded, defects such as eutectic melting are likely to occur.

The forging process is preferably performed at a temperature of 500° C. or higher and 550° C. or lower.

### (Solution Treatment Process)

The solution treatment process is a process in which the forged product obtained in the forging process is heated and formed into a solution, and thus the distortion introduced in the forging process is reduced, and the solute element is solid-solutionized.

In the present embodiment, the forged product is subjected to a solution treatment in which it is heated from 20° C. to 530° C. at a heating rate of 5.0° C./min or more and held at 530 to 560° C. for 0.3 to 3 hours. The heating rate from room temperature to the above treatment temperature is preferably 5.0° C./min or more. When the treatment temperature is lower than 530° C., there is a risk of solid-solutionization of solute elements becoming insufficient. On the other hand, when the treatment temperature is higher than 560° C., solid-solutionization of solute elements is further promoted, but there is a risk of eutectic melting and recrystallization easily occurring. In addition, when the heating rate is less than 5.0° C./min, there is a risk of Mg₂Si coarsely precipitating. On the other hand, when the treatment temperature is lower than 530° C., there is a risk of solutionizing not proceeding and high-strength due to aging precipitation not being easily achieved.

In the solution treatment process, it is preferable to perform a solution treatment in which the product is held at 535° C. or higher and 555° C. or lower for 1 hour or longer and 3 hours or shorter.

### (Quenching Treatment Process)

The quenching treatment process is a process in which the forged product in a solid-solution state obtained in the solution treatment process is rapidly cooled to from an over-saturated solid solution. Within 5 to 60 seconds after the solution treatment, the entire surface of the forged product is brought into contact with quenching water and quenching is performed in a water tank for longer than 1 minute and 40 minutes or shorter.

In the present embodiment, the forged product is put into a water tank in which water (quenching water) is stored, and the forged product is immersed in water to perform a quenching treatment. The water temperature in the water tank is preferably 20° C. or higher and 60° C. or lower. It is preferable that the forged product be put into the water tank so that the entire surface of the forged product comes into contact with water within 5 seconds or longer and 60 seconds or shorter after the solution treatment. The time for which the forged product is immersed in water varies depending on the size of the cast product, but is, for example, longer than 1 minute and 30 minutes or shorter.

### (Aging Treatment Process)

The aging treatment process is a process in which the forged product is heated and held at a relatively low temperature to precipitate over-saturated solid-solution elements, and an appropriate hardness is imparted. The forged product that has undergone the quenching treatment process is subjected to an aging treatment in which it is heated at a temperature of 180° C. to 220° C. for 0.5 hours to 8 hours. In the aging treatment process, the forged product that has undergone the quenching treatment process is preferably subjected to an aging treatment in which it is heated at a temperature of 185° C. or higher and 205° C. or lower for 0.5 hours or longer and 3 hours or shorter.

In the present embodiment, the forged product after the quenching treatment process is subjected to an aging treatment in which it is heated at a temperature of 170° C. or higher and 210° C. or lower and held at that temperature for 0.5 hours or longer and 7 hours or shorter. When the treatment temperature is lower than 170° C. or the holding time is shorter than 0.5 hours, there is a risk of Mg₂Si-based precipitates that improve the tensile strength not being able to grow sufficiently. On the other hand, when the treatment temperature is higher than 190° C. or when the holding time is longer than 7 hours, there is a risk of Mg₂Si-based precipitates becoming too coarse and the tensile strength not being able to be improved sufficiently.

### EXAMPLES

Next, specific examples of the present invention will be described, but the present invention is not particularly limited to these examples.

### Examples 1 to 7 and Comparative Examples 1 to 5

### Production of Continuous Cast Product

First, aluminum alloys having alloy compositions (the remainder being made up of aluminum) shown in the following Table 1 were prepared. Using the prepared aluminum alloys as raw materials, continuous cast products having a circular cross section with a diameter of 84 mm were produced using the above vertical continuous casting device and cooling method. Examples 1 to 5 and Comparative Examples 1 to 5 were suspension arm test pieces having the same composition and produced under the same manufacturing conditions.

TABLE 1

| | Si | Fe | Cu | Mn | Mg | Cr | Zn | Ti | B | Zr |
|---|---|---|---|---|---|---|---|---|---|---|
| Example 1 | 0.720 | 0.248 | 0.335 | 0.120 | 1.082 | 0.243 | 0.007 | 0.019 | 0.002 | 0.001 |
| Example 2 | 0.720 | 0.248 | 0.335 | 0.120 | 1.082 | 0.243 | 0.007 | 0.019 | 0.002 | 0.001 |
| Example 3 | 0.720 | 0.248 | 0.335 | 0.120 | 1.082 | 0.243 | 0.007 | 0.019 | 0.002 | 0.001 |
| Example 4 | 0.720 | 0.248 | 0.335 | 0.120 | 1.082 | 0.243 | 0.007 | 0.019 | 0.002 | 0.001 |
| Example 5 | 0.720 | 0.248 | 0.335 | 0.120 | 1.082 | 0.243 | 0.007 | 0.019 | 0.002 | 0.001 |
| Example 6 | 0.654 | 0.200 | 0.268 | 0.080 | 1.214 | 0.192 | 0.003 | 0.021 | 0.005 | 0.001 |
| Example 7 | 0.654 | 0.200 | 0.268 | 0.080 | 1.214 | 0.192 | 0.003 | 0.021 | 0.005 | 0.001 |
| Comparative | 0.720 | 0.248 | 0.335 | 0.120 | 1.082 | 0.243 | 0.007 | 0.019 | 0.002 | 0.001 |
| Example 1 | | | | | | | | | | |
| Comparative | 0.720 | 0.248 | 0.335 | 0.120 | 1.082 | 0.243 | 0.007 | 0.019 | 0.002 | 0.001 |
| Example 2 | | | | | | | | | | |
| Comparative | 0.720 | 0.248 | 0.335 | 0.120 | 1.082 | 0.243 | 0.007 | 0.019 | 0.002 | 0.001 |
| Example 3 | | | | | | | | | | |
| Comparative | 0.720 | 0.248 | 0.335 | 0.120 | 1.082 | 0.243 | 0.007 | 0.019 | 0.002 | 0.001 |
| Example 4 | | | | | | | | | | |
| Comparative | 0.720 | 0.248 | 0.335 | 0.120 | 1.082 | 0.243 | 0.007 | 0.019 | 0.002 | 0.001 |
| Example 5 | | | | | | | | | | |

### (Manufacturing of Suspension Arm)

Next, the obtained continuous cast product was subjected to a homogenization heat treatment process (only Comparative Examples 1 to 5), a forging processing process (including the peeling treatment), a solution treatment process, a quenching treatment process, and an artificial aging treatment process in that order to obtain the suspension arm 100 having the shape shown in FIG. 11. The conditions for the homogenization heat treatment process (only Comparative Examples 1 to 5), the forging processing process, the solution treatment process, the quenching treatment process, and the artificial aging treatment process are shown in the following Table 2.

TABLE 2

| | | | | | | | | Quenching treatment process | | | | |
|---|---|---|---|---|---|---|---|---|---|---|---|---|
| | | | | | | | | Time | | | | |
| | Homogenization heat | | | Forging | | | | until | | | Artificial aging | |
| | treatment process | | | processing | Solution treatment process | | | immersion | Water | Water | treatment process | |
| | Heating | Temper- | Holding | process | Heating | Temper- | Holding | in | temper- | immersion | Temper- | Holding |
| | rate | ature | time | Temperature | rate | ature | time | water | ature | time | ature | time |
| | [° C./min] | [° C.] | [min] | [° C.] | [° C./min] | [° C.] | [min] | [sec] | [° C.] | [min] | [° C.] | [min] |
| Example 1 | | | | 535 | 10 | 545 | 120 | 15 | 25 | 1.5 | 195 | 90 |
| Example 2 | | | | 510 | 10 | 545 | 120 | 15 | 25 | 1.5 | 195 | 90 |
| Example 3 | | | | 500 | 10 | 545 | 120 | 15 | 25 | 1.5 | 195 | 120 |
| Example 4 | | | | 520 | 10 | 545 | 90 | 15 | 25 | 1.5 | 195 | 90 |
| Example 5 | | | | 525 | 10 | 545 | 90 | 15 | 25 | 1.5 | 195 | 120 |
| Example 6 | | | | 520 | 10 | 535 | 120 | 15 | 40 | 1.5 | 200 | 160 |
| Example 7 | | | | 520 | 10 | 535 | 120 | 15 | 40 | 1.5 | 200 | 160 |
| Comparative | 1.5 | 470 | 420 | 530 | 10 | 500 | 120 | 15 | 25 | 0.5 | 195 | 90 |
| Example 1 | | | | | | | | | | | | |
| Comparative | 1.5 | 470 | 420 | 525 | 10 | 500 | 120 | 15 | 25 | 0.5 | 195 | 90 |
| Example 2 | | | | | | | | | | | | |
| Comparative | 1.5 | 470 | 420 | 510 | 10 | 500 | 120 | 15 | 25 | 0.5 | 195 | 120 |
| Example 3 | | | | | | | | | | | | |
| Comparative | 1.5 | 470 | 420 | 520 | 10 | 500 | 90 | 15 | 25 | 0.5 | 195 | 90 |
| Example 4 | | | | | | | | | | | | |
| Comparative | 1.5 | 470 | 420 | 525 | 10 | 500 | 90 | 15 | 25 | 0.5 | 195 | 120 |
| Example 5 | | | | | | | | | | | | |

### [Evaluation]

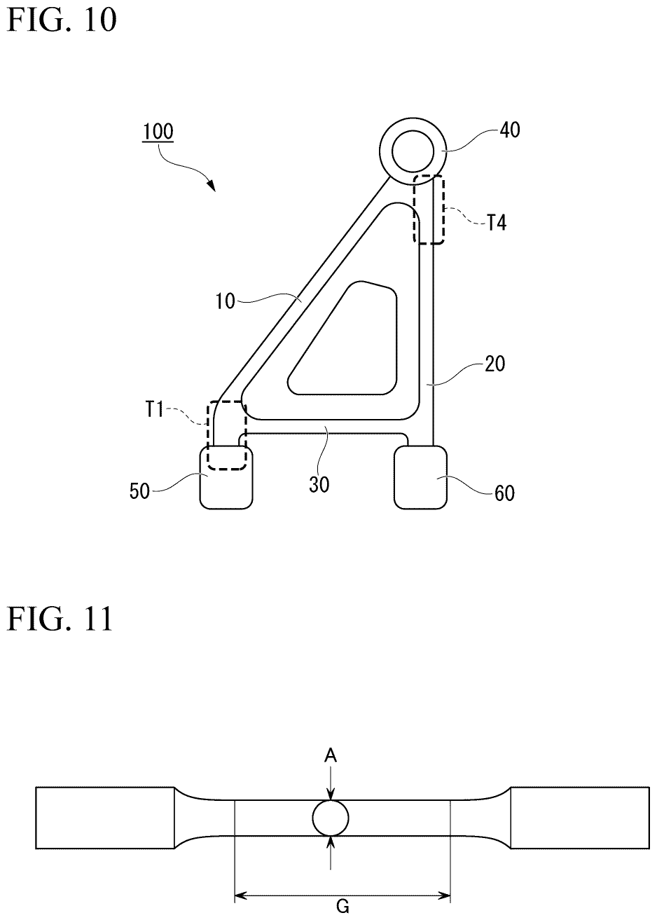

The tensile strength (MPa) was evaluated at a T1 position and a T4 position (refer to parts surrounded by dotted lines in FIG. 10) on the suspension arm 100 of Examples 1 to 7 and Comparative Examples 1 to 5 obtained as described above. Table 3 shows the average values of the tensile strength (MPa) at the T1 position and the T4 position in Examples 1 to 5, Examples 6 and 7, and Comparative Examples 1 to 5, and the ratio of the tensile strength (MPa) at the T4 position to the tensile strength at the T1 position using the average value.

In addition, the equivalent strain of the entire suspension arm 100 of Examples 1 to 7 and Comparative Examples 1 to 5 is obtained using forging analysis software “DEFORM.”

The part indicated by the T1 position corresponds to the part with the minimum equivalent strain, the thickest part of the first arm part, and the part with the smallest proportion of large-angle grain boundaries with a crystal orientation difference of 15° or higher.

The part indicated by the T4 position corresponds to the part with the maximum equivalent strain, the thinnest part of the second arm part, and the part with the largest proportion of large-angle grain boundaries with a crystal orientation difference of 15° or higher.

### <Evaluation of Mechanical Properties (Tensile Properties)>

At each of the T1 position and the T4 position on the suspension arm 100, a prismatic component for producing a mechanical property evaluation test piece was collected. The obtained prismatic component was processed to produce a cylindrical mechanical property evaluation test piece shown in FIG. 11. The mechanical property evaluation test piece had a parallel part diameter A of 6.4 mm and a gauge distance G of 25.4 mm. A tensile test was performed on the mechanical property evaluation test piece at room temperature (25° C.).

For each of Examples 1 to 7 and Comparative Examples 1 to 5, the equivalent strain (mm/mm) determined by a simulation was 1.2 to 4.9 (mm/mm).

TABLE 3

| | T1 | T4 | Ratio |
|---|---|---|---|
| Example 1 | 370.6 | 320.8 | 0.866 |
| Example 2 | 365.4 | 317.5 | 0.869 |
| Example 3 | 365.4 | 327.1 | 0.895 |
| Example 4 | 366.7 | 325.7 | 0.888 |
| Example 5 | 367.1 | 317.6 | 0.865 |
| Example 6 | 334.4 | 313.4 | 0.937 |
| Example 7 | 333.3 | 319.1 | 0.957 |
| Comparative | 369.8 | 304.3 | 0.823 |
| Example 1 | | | |
| Comparative | 368.1 | 308.3 | 0.838 |
| Example 2 | | | |
| Comparative | 367.5 | 303.0 | 0.824 |
| Example 3 | | | |
| Comparative | 367.7 | 307.6 | 0.837 |
| Example 4 | | | |
| Comparative | 367.9 | 300.8 | 0.818 |
| Example 5 | | | |

As shown in Table 3, in Comparative Examples 1 to 5, the ratio of the tensile strength at the T4 position to the tensile strength at the T1 position was less than 0.84.

On the other hand, in Examples 1 to 7, the ratio of the tensile strength at the T4 position to the tensile strength at the T1 position as 0.84 or more (more specifically, 0.86 or more), and the variation in tensile strength was reduced compared to Comparative

### Examples 1 to 5

In addition, in Examples 6 and 7, the tensile strength at the T1 position was reduced compared to Examples 1 to 5, but the variation in tensile strength was further reduced compared to Examples 1 to 5 (specifically, 0.93 or more).

### REFERENCE SIGNS LIST

10 First arm part
20 Second arm part
30 Arm connecting part
40 Wheel-side connecting part
50, 60 Vehicle body-side connecting part
100 Suspension arm

1. A suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, which is a forged product in which the ratio of the tensile strength of a part (T1) with the minimum equivalent strain to the tensile strength of a part (T4) with the maximum equivalent strain is 0.84 or more and 1 or less.

2. The suspension arm according to claim 1, wherein the part with the minimum equivalent strain has a tensile strength of 350 MPa or more.

3. A suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, composed of
a pair of bifurcated arm parts, an arm connecting part disposed between the pair of arms, a wheel-side connecting part positioned at the starting point of bifurcations of the pair of arms, and vehicle body-side connecting parts provided at one end of each of the pair of arms,
which is a forged product in which, in the pair of arms, the ratio of the tensile strength of the thinnest part to the tensile strength of the thickest part is 0.84 or more and 1 or less.

4. The suspension arm according to claim 3,
wherein the thickest part has a tensile strength of 350 MPa or more.

5. A suspension arm made from an aluminum alloy having an alloy composition containing Cu in a range of 0.25 mass % or more and 0.37 mass % or less, Mg in a range of 0.95 mass % or more and 1.25 mass % or less, Si in a range of 0.6 mass % or more and 0.75 mass % or less, Mn in a range of 0.05 mass % or more and 0.12 mass % or less, Fe in a range of 0.15 mass % or more and 0.35 mass % or less, Zn in a range of 0.25 mass % or less, Cr in a range of 0.050 mass % or more and 0.26 mass % or less, Ti in a range of 0.01 mass % or more and 0.1 mass % or less, B in a range of 0.001 mass % or more and 0.03 mass % or less, and Zr in a range of 0.0010 mass % or more and 0.050 mass % or less, with the remainder being made up of Al and unavoidable impurities, which is a forged product in which the ratio of the tensile strength of a part with the largest proportion of large-angle grain boundaries with a crystal orientation difference of 15° or higher to the tensile strength of a part with the smallest proportion of large-angle grain boundaries with a crystal orientation difference of 15° or higher is 0.84 or more and 1 or less.

6. The suspension arm according to claim 5, wherein the part with the smallest proportion of large-angle grain boundaries with a crystal orientation difference of 15° or higher has a tensile strength of 350 MPa or more.

7. The suspension arm according to claim 1, wherein the equivalent strain due to forging processing is between 1.0 and 5.5.

8. A method for manufacturing the suspension arm according to claim 1, comprising:
a molten metal forming process in which a molten aluminum alloy is obtained;
a casting process in which the obtained molten metal is cast to obtain a cast product;
a forging process in which the cast product is subjected to plastic processing by performing material-heating at a temperature of 500° C. to a melting point without performing a homogenizing treatment process to obtain a forged product;
a solution treatment process in which the obtained forged product is subjected to a solution treatment in which it is heated from 20° C. to 530° C. at a heating rate of 5.0° C./min or more and held at 530 to 560° C. for 0.3 to 3 hours;
a quenching process in which, within 5 to 60 seconds after the solution treatment, the entire surface of the forged product is brought into contact with quenching water, and quenching is performed in a water tank for longer than 1 minute and 40 minutes or shorter; and
an aging treatment process in which the forged product that has undergone the quenching treatment process is subjected to an aging treatment in which heating is performed at a temperature of 180° C. to 220° C. for 0.5 hours to 8 hours.

9. The method for manufacturing a suspension arm according to claim 8,
wherein the forging process is performed at a temperature of 500° C. or higher and 550° C. or lower,
in the solution treatment process, a solution treatment in which holding is performed at 535° C. or higher and 555° C. or lower for 1 hour to 3 hours is performed, and
in the aging treatment process, the forged product that has undergone the quenching treatment process is subjected to an aging treatment in which heating is performed at a temperature of 185° C. or higher and 205° C. or lower for 0.5 hours to 3 hours.

10. The suspension arm according to claim 2, wherein the equivalent strain due to forging processing is between 1.0 and 5.5.

11. The suspension arm according to claim 3, wherein the equivalent strain due to forging processing is between 1.0 and 5.5.

12. The suspension arm according to claim 4, wherein the equivalent strain due to forging processing is between 1.0 and 5.5.

13. The suspension arm according to claim 5, wherein the equivalent strain due to forging processing is between 1.0 and 5.5.

14. The suspension arm according to claim 6, wherein the equivalent strain due to forging processing is between 1.0 and 5.5.

15. A method for manufacturing the suspension arm according to claim 3, comprising:
a molten metal forming process in which a molten aluminum alloy is obtained;
a casting process in which the obtained molten metal is cast to obtain a cast product;
a forging process in which the cast product is subjected to plastic processing by performing material-heating at a temperature of 500° C. to a melting point without performing a homogenizing treatment process to obtain a forged product;
a solution treatment process in which the obtained forged product is subjected to a solution treatment in which it is heated from 20° C. to 530° C. at a heating rate of 5.0° C./min or more and held at 530 to 560° C. for 0.3 to 3 hours;
a quenching process in which, within 5 to 60 seconds after the solution treatment, the entire surface of the forged product is brought into contact with quenching water, and quenching is performed in a water tank for longer than 1 minute and 40 minutes or shorter; and
an aging treatment process in which the forged product that has undergone the quenching treatment process is subjected to an aging treatment in which heating is performed at a temperature of 180° C. to 220° C. for 0.5 hours to 8 hours.

16. A method for manufacturing the suspension arm according to claim 5, comprising:
a molten metal forming process in which a molten aluminum alloy is obtained;
a casting process in which the obtained molten metal is cast to obtain a cast product;
a forging process in which the cast product is subjected to plastic processing by performing material-heating at a temperature of 500° C. to a melting point without performing a homogenizing treatment process to obtain a forged product;
a solution treatment process in which the obtained forged product is subjected to a solution treatment in which it is heated from 20° C. to 530° C. at a heating rate of 5.0° C./min or more and held at 530 to 560° C. for 0.3 to 3 hours;
a quenching process in which, within 5 to 60 seconds after the solution treatment, the entire surface of the forged product is brought into contact with quenching water, and quenching is performed in a water tank for longer than 1 minute and 40 minutes or shorter; and
an aging treatment process in which the forged product that has undergone the quenching treatment process is subjected to an aging treatment in which heating is performed at a temperature of 180° C. to 220° C. for 0.5 hours to 8 hours.

17. The method for manufacturing a suspension arm according to claim 15,
wherein the forging process is performed at a temperature of 500° C. or higher and 550° C. or lower,
in the solution treatment process, a solution treatment in which holding is performed at 535° C. or higher and 555° C. or lower for 1 hour to 3 hours is performed, and
in the aging treatment process, the forged product that has undergone the quenching treatment process is subjected to an aging treatment in which heating is performed at a temperature of 185° C. or higher and 205° C. or lower for 0.5 hours to 3 hours.

18. The method for manufacturing a suspension arm according to claim 16,
wherein the forging process is performed at a temperature of 500° C. or higher and 550° C. or lower,
in the solution treatment process, a solution treatment in which holding is performed at 535° C. or higher and 555° C. or lower for 1 hour to 3 hours is performed, and
in the aging treatment process, the forged product that has undergone the quenching treatment process is subjected to an aging treatment in which heating is performed at a temperature of 185° C. or higher and 205° C. or lower for 0.5 hours to 3 hours.
